(19) United States
(12) Patent Application Publication
(10) Pub. No.: US 2009/0037830 A1
(43) Pub. Date: Feb. 5, 2009

(54) SOFTWARE SOLUTION FOR LOCALIZATION OF SOFTWARE APPLICATIONS USING AUTOMATICALLY GENERATED PLACEHOLDERS

(75) Inventors: AMEET ANIL KULKARNI, WESTBOROUGH, MA (US); PHILIPPE RIAND, CHELMSFORD, MA (US); DAVID D. TAIEB, CHARLESTOWN, MA (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/833,344

(22) Filed: Aug. 3, 2007

(51) Int. Cl. G06F 3/048; G06F 9/44

(52) U.S. Cl. 715/764; 717/137

(57) ABSTRACT

The present invention discloses a software solution for localization/globalization of software applications. Localization refers to a language specific version of globalized software. The invention can generate externalized language specific files that are decoupled from source code, while alleviating many mistakes and problems inherent in legacy localization methodologies. That is, the invention provides an end-to-end framework that automatically replaces source code strings with placeholders, which are linked to national language (NL) specific strings of a target language. During build time, an executable can be generated that is customized for the target language. The original source code remains unchanged, which makes the globalization process described transparent to software developers. Further, the placeholders are automatically generated for each build, which resolves many problems with manually specifying keys that replace text, such as orphaned keys, duplicate keys, and the like.

### BACKGROUND

1. Field of the Invention

The present invention relates to the field of software globalization and, more specifically, to a software solution for localization of software applications using automatically generated placeholders such as keys that replace language specific strings which are indexed to language specific strings contained in a separate file.

2. Description of the Related Art

Many software applications are intended for use in many countries. Supporting various countries' native languages requires a significant amount of development lime and planning. Some companies' financial standing in the worldwide marketplace can depend on its ability to make its products widely available through localization, which refers to adapting the software so that text of the software products appear in a “local” language. One approach to localize a software application is to make language-specific changes in in-line source code. Another approach is to link source code text to one or more external localization files, each localization file corresponding to a specific language.

There are many problems that can occur during the localization of software applications. For example, localizable strings are sometimes put in-line in the source code by mistake. In certain instances, it can be tough to detect if a duplicate key, or localizable string, exists. As software design changes, localized strings can be orphaned, or even forgotten. Also, with some current tools, the original source code is modified and localized strings are replaced with tags to identify each localized string. These tags can make the source code harder to read and more incoherent. These problems increase product development time and decrease overall programmer productivity which adds to product development cost.

### SUMMARY OF THE INVENTION

The present invention discloses a software enhancement for build time localization of software applications. Localization refers to a language specific version of globalized software. The invention can generate externalized language specific files that are decoupled from source code, while alleviating many mistakes and problems inherent in legacy localization methodologies. That is, the invention provides an end-to-end framework that automatically replaces source code strings with placeholders, which are linked to national language (NL) specific strings of a target language. During build time, an executable can be generated that is customized for the target language. The original source code remains unchanged, which makes the globalization process described transparent to software developers. Further, the compiled code including replacement strings can be discarded after the executable is generated. That is, each time a new executable is needed, the NL replacements can occur to create intermediate code, the intermediate code can be used to generate an executable, and the intermediate code can, thereafter, be discarded. The placeholders that replace source code strings can be automatically generated for each build, which resolves many problems with manually specifying keys that replace text, such as orphaned keys, duplicate keys, and the like.

More specifically, an inventive design tool can be used to automatically identify localizable strings. Developers can tag these strings for handling within the design tool, such as by indicating whether each string is one to be localized or not. The design tool can also permit entries of a localization table to be constructed for each tagged string. When the source code is compiled or interpreted, tagged strings can be automatically replaced with corresponding strings of an identified localization table. Further, a reporting component can automatically generate information concerning a number of tagged and untagged strings, tagged strings lacking replacement strings, and the like.

A few advantages that the disclosed invention has over conventional localization processes become immediately evident. Source code, for example, remains clean and easy for a developer to understand as the code includes text strings in a developer-understandable language, instead of including difficult to interpret and relatively meaningless keys. Externalization of strings to a localized language remains largely transparent to a source code developer. In fact, the NL specific intermediary code (unlike the persisting source code) can be a non-persisting software artifact, which can be discarded once executable results are generated. Further, a non-programmer (e.g., a linguist knowledgeable in a target language and the original language of the source code) is able to use the development tool to localize strings independent of other software design activities. Dynamically generating keys alleviates problems with missing or orphan keys, which can cause executing code to freeze or behave unexpectedly.

The present invention can be implemented in accordance with numerous aspects consistent with the material presented herein. For example, one aspect of the present invention can include a method for localizing source code strings. The method can include a step of identifying software source code that includes a set of base language strings. Base language strings can be automatically detected by a software routine. The source code can be visually presented within a graphical user interlace (GUI) along with visual indicators to identify the automatically detected base language strings. User input can be received via the GUI to annotate details of the base language strings. For each base language string, an equivalent string in a target language can be determined. Each base language string can be automatically replaced with an automatically generated placeholder to construct language independent or globalized source code. Software can index each placeholder against the target language string associated with the base language string that the placeholder replaced. An executable customized for the target language can be generated from the indexing results and the language independent source code.

Another aspect of the present invention can include development software for localizing source code that includes a localizable string detection engine, a placeholder generation engine, a target-language-to-placeholder indexing engine, and a build engine. The localizable string detection engine can automatically detect each base language string contained in source code. The placeholder generation engine can create a placeholder for each detected base language string and can substitute each base language string of the source code with a created placeholder. The target-language-to-placeholder indexing engine can index each placeholder of the source code against a target language item, wherein the target language item that is indexed is associated with a base language string that the indexed placeholder replaced. The build engine can automatically generate an executable customized for the target language based upon an index file generated by the target-language-to-placeholder indexing engine and a modified source code file generated by the placeholder generation engine.

Still another aspect of the present invention can include a software development interface that includes a source code viewer. The source code viewer can be used to visually distinguish automatically detected base language strings within source code from other source code text, wherein each of the automatically detected base language strings are strings that are to be localized though actions taken via the software development interface. At least one interface element of the source code viewer can permit a user to categorize options for an associated base language string. Selectable categorization options can include, for example, national language strings, national language errors, national language information items, national language warnings, and non-national language strings. A software routine can use the tagged version of the software source code to generate a language independent version of the source code within which each of the detected base language strings has been replaced by an automatically generated placeholder. The development interface can also include a language specification interface configured to present each of the detected base language strings and to permit a user to specify/edit a target language string that corresponds to each of the detected base language strings. The target language strings can be indexed against each of the automatically generated placeholders so that each target language string is associated with a placeholder that has replaced a base language string corresponding to the target language string. Additionally, a build creation interface can permit a user to selectively create a software build based upon the source code. At least one of the options of the build interface can automatically create an executable customized for the target language based upon a user specified file for a language independent version of the source code and based upon a user specified indexed file that indexes the automatically generated placeholders and the target language strings established through the language specification interlace.

It should be noted that various aspects of the invention can be implemented as a program for controlling computing equipment to implement the functions described herein, or as a program for enabling computing equipment to perform processes corresponding to the steps disclosed herein. This program may be provided by storing the program in a magnetic disk, an optical disk, a semiconductor memory, or any other recording medium. The program can also be provided as a digitally encoded signal conveyed via a carrier wave. The described program can be a single program or can be implemented as multiple subprograms, each of which interact within a single computing device or interact in a distributed fashion across a network space.

It should also be noted that the methods detailed herein can also be methods performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system that is capable of performing build time localization of software applications in accordance with an embodiment of the inventive arrangements disclosed herein.

FIG. 2 is a schematic diagram of a set of interfaces used for build-time localization of software applications in accordance with an embodiment of the inventive arrangements disclosed herein.

FIG. 3 is a flow chart of a method for localizing software in accordance with an embodiment of the inventive arrangements disclosed herein.

### DETAILED DESCRIPTION OF THE INVENTION

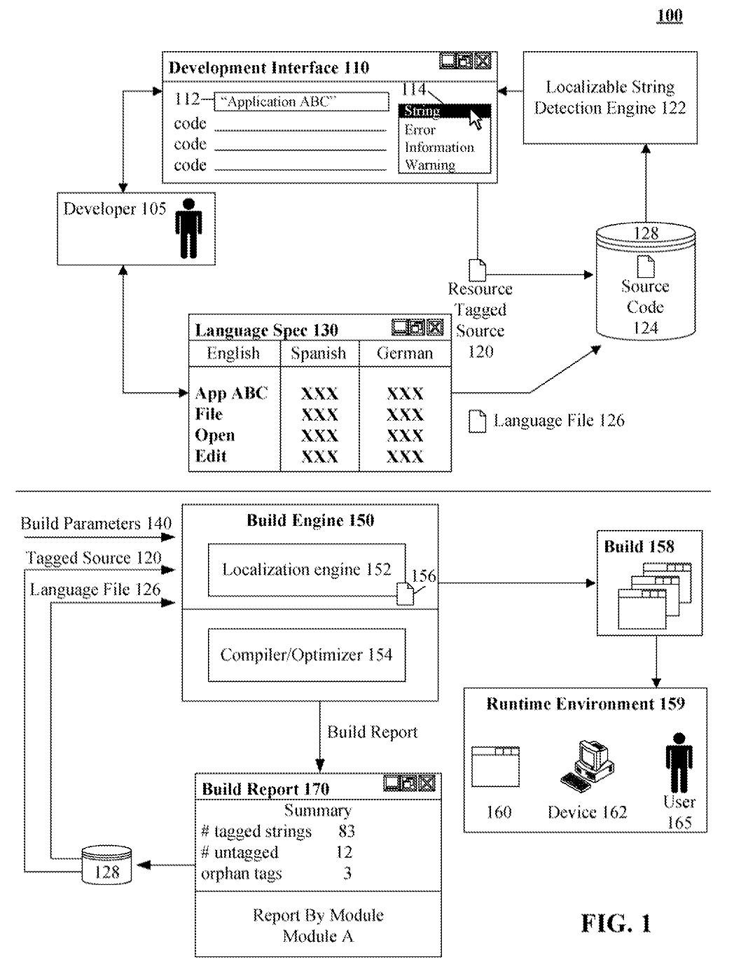

FIG. 1 is a schematic diagram illustrating a system 100 that is capable of performing build time localization of software applications. System 100 permits developer 105 to work with easy-to-understand source code 124, yet the system 100 still decouples the source code 120 used in a build 158 from language specific 112 strings. System 100 makes customization of an executable 160 for a specific language an efficient process that increases developer 105 productivity, while reducing human error. Reduction of errors results from an ability of the system 100 to automatically generate placeholders for localizable strings 112, while linking the automatically generated placeholders to corresponding language strings. Each time a build 158 occurs, different placeholders can be automatically created.

In system 100, source code 124 including strings in a base language can be processed by a localizable string detection engine 122, which interacts with a development interface 110. Specifically, the interlace 110 can visually indicate base language strings 112, such as by highlighting each detected string. A developer 105 can mark using selector 114 each tagged string 112 as being a presentation string, an error string, an information string, a warning string, an incorrect detection, and the like. After tagging, a resource tagged source 120 file can be generated and stored in a data store 128.

Each tagged string 112 can be automatically placed in a language specific table 130. A linguist, the developer 105, and/or an automated translation software routine can specify equivalents for tagged strings in various languages for which localization of the source code 124 is desired. For example, base language strings can include English strings and equivalent table 130 items can include Spanish and German translations of the corresponding base language (English) strings. A localization file 126 can be generated from the table 130 entries.

After files 120 and 126 have been generated, a build engine 150 can accept the tagged source code 120, the localization file 126, and build parameters 140, which the engine 150 uses to generate a build 158 that includes an executable version 160 of the software with localized strings. Build parameters 140 can specify a target naturalization language and other build related parameters. The build engine 150 can also generate a build report 170, which includes results from operations of a localization engine 152, and which can be stored in data store 128.

The build report 170 can provide comprehensible information specifying details of the localization effort. For example, the build report 170 can indicate a number of tagged and untagged strings in the build. The report 170 can also indicate a number of duplicate keys, if any, which include a file name and line number. Additionally, the report 170 can report the number of strings tagged in a code module on a per-module basis. Each tagged string can be identified by a file name, a line number, and/or a description in the report 170. A number of orphaned tags, un-annotated tags, and tags not having a corresponding language entry associated with them, can also be reported. Moreover, the report 170 can contain a number of keys deleted, changes, or values changed since a previous revision or software version as well as since a software freeze milestone.

The localization engine 152 can be used to dynamically generate placeholders, which replace the tagged strings 112 of the source 120. Each of these dynamically generated placeholders can be linked to corresponding entries of the localization file 126. In one embodiment, a properties 156 file can be created, which specifies the linkages between the placeholders and the corresponding entries.

Once the placeholders have replaced strings and once localized strings have been linked to the placeholders, a compiler/optimizer 154 can be used to create build 158, which includes a localized executable 160. The localized executable 160 can be deployed to a runtime environment 159, where a user 165 can utilize a device 162 upon which the executable 160 runs. In one implementation, the build engine 150 can execute in a development environment before a build 158 is deployed. After a build 158 is generated, the intermediary file that includes national language replacement strings (e.g., the file processed by compiler/optimizer 154) can be discarded. Each build cycle can result in a different intermediary file being temporarily generated.

It should be noted that the system 100 can be utilized for any software language or software design methodology. For example, the build engine 150 can execute at compile time for a compiled language, such as C or C++. In a JAVA implementation and in accordance with current JAVA standards, the association file 126 can be a .properties file, the tagged source 120 can be a .java file, and the build parameters 140 can be a .localization file. Specifics of the invention can be easily adapted for conventions of any programming language.

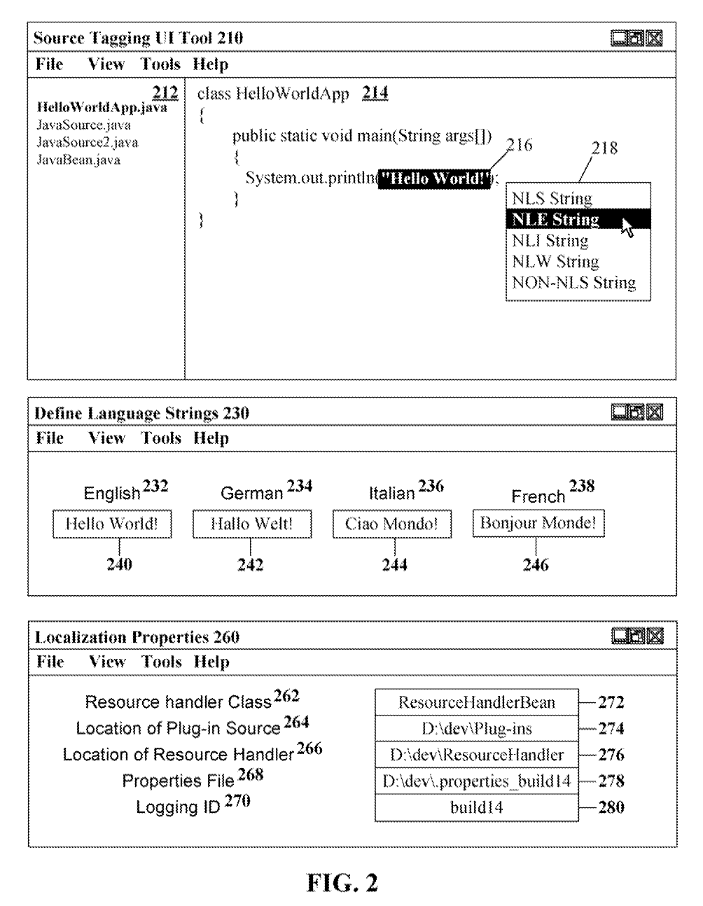

FIG. 2 is a schematic diagram of a set of interfaces 210, 230, and 260 used for build-time localization of software applications in accordance with an embodiment of the inventive arrangements disclosed herein. The interlaces can include a source tagging interface tool 210, a define language strings interface 230, and a localization properties interface 260. In one embodiment, the interfaces 210, 230, and 260 can be used in a context of a system 100.

Details of the interfaces 210, 230, and 260 are presented for illustrative purposes only and are not to be interpreted as an invention constraint. For example, the interface content, elements, element arrangement, and the like, can be modified as suitable for specifics of a system in which the interfaces 210, 230, and 260 are used. For example, if one or more of the interfaces 210, 230, and 260 are plug-ins for an integrated development environment (IDE) (e.g., ECLIPSE), then the interfaces can use toolbars, icons, menu bars, and the like, designed to provide a cohesive look and feel with other components of the IDE.

The source tagging tool interface 210 can be used to open source code files and specify localizable strings. A software engine, such as engine 122, can be used to detect and visually indicate 216 a set of localizable strings, such as string 216. The tagging tool interface 210 can include a source code file list 212, which can be used to select a source code file within which to view tag localizable strings. Interface 210 can also include a source code display 214 used to display the source code and visual indicators (216) of the selected code file 212. Selecting or pointer focusing upon a visually indicated siring 216 can invoke a pop-up menu 218. The menu 218 can permit a user to specify a category for the indicated string 216.

For example, the menu can be used to classify the localized string as a national language (NL) string (NLS), a NL error (NLE) string, a NL information (NLI) string, a NL warning (NLW) string, or a non NL string (NON-NLS). These classifications can aid the localization engine in determining how and when to replace each localizable string. For example, a localization engine can be adjusted to replace only NLE and NLW strings.

The define language strings interface 230 can be an interlace used to define a localizable string and its equivalent in different locales. Locales such as locales 232-238 can be used to separate the different definitions, but the inventive arrangements disclosed herein are not limited to locales 232-238. Fields 240-246 can be used to set the equivalent string to the corresponding locale 232-238. The fields 240-246 can include user specified values and/or automatically determined default values. In one embodiment, the interface 230 and interface 210 can be integrated in a single window, where when a string 216 is selected a user is presented with an option to define a localized language variant for the string 216.

A localization properties interlace 260 can be an interface used to set build parameters. In a JAVA implementation, these parameters can be specified in a .localization file. Localization options of interface 260 can include, but are not limited to, resource handler class 262, location of plug-in source 264, location of resource handler 266, properties file 268, and logging ID 270. Fields 272-280 can be used to display/edit the current values of the associated option.

More specifically, option resource handler class 262 can be used to specify the class in the source code that handles the software application's resources. In one embodiment, this can be used with the localization engine to manage localization resources. Option location of plug-in source 264 can be used to specify the folder with the plug-in source for build-time localization. In one embodiment, the plug-in folder may be required. Option location of resource handler 266 can be used to define the location of the software application's resource handler. In one embodiment, this can be used with the localization engine to manage localization resources. Option properties file 268 can be used to specify the filename of the generated properties file. In some instances, a developer may want multiple copies of the .properties file built with each build, to reference in case of error. Option properties file 268 can be used to create multiple .properties files. Option logging ID 270 can be used to specify the ID to log errors. In some instances, it can be helpful to log under a different ID per build. This helps separate errors per iteration of source code.

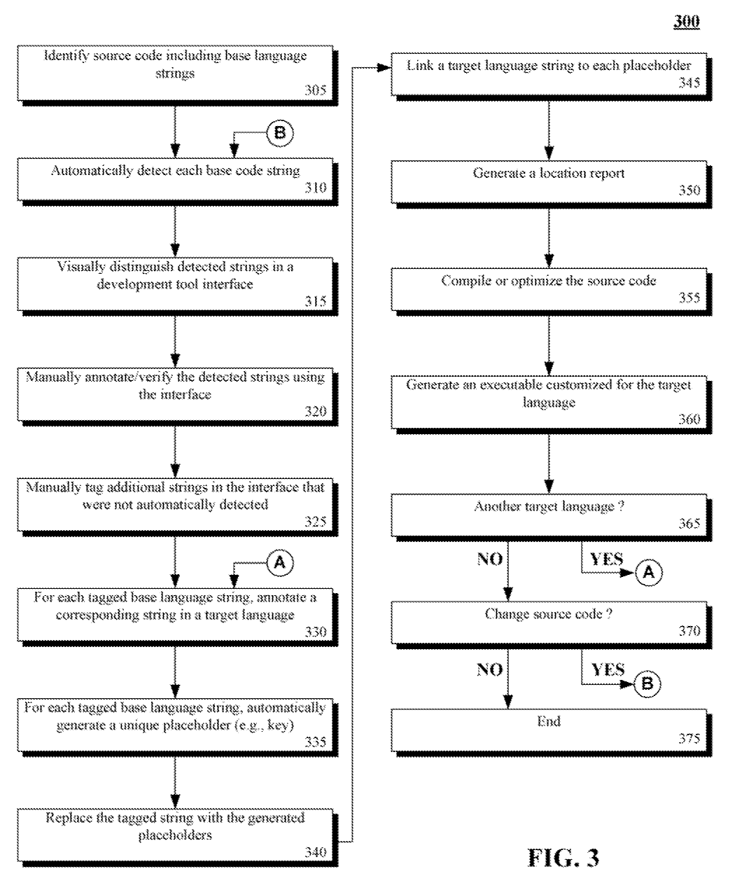

FIG. 3 is a flow chart of a method 300 for localizing software in accordance with an embodiment of the inventive arrangements disclosed herein. The method 300 can be performed in the context of a system 100 or similar system that includes a software development tool that dynamically generates placeholders for tagged strings in a base language and links these placeholders to entries of a target language.

The method 300 can begin in step 305, where source code can be identified that includes a set of strings written in a base language. In step 310, each base language string in the source code can be automatically detected. In step 315, the detected strings can be visually distinguished in a development tool interface. For example, each detected string can be highlighted, can be presented in a different font or font color, can be associated with an identifying icon, and the like. In step 320, a user can manually annotate/verify/categorize the detected strings using the interface. In step 325, the user can optionally tag additional, non-detected strings of the source code through the interface, which allows a user to identify applicable strings in the source code that a detection engine failed to detect.

In step 330, for each tagged base language string, a corresponding string can be annotated in a target language. Target language strings can be created automatically with a translation software routine and/or manually through user input. In one arrangement, each target language string entry can be specified directly in the interface in which the tagged source code is shown. In another arrangement, a separate interface, such as a table having multiple columns, each column representing a different language and having multiple rows, each representing a string entry, can be user editable and can be used to specify equivalents for tagged strings. In still another arrangement, a data file of predefined strings can be used to establish default values, which are automatically used to populate annotated string entries. Standardized naming conventions for common interface elements (e.g., File, Edit, View, Insert, Format, Help, and the like) can encourage the use of default values as a time saving mechanism for localizing a software product.

In step 335, for each tagged base language string, a unique placeholder can be automatically generated for each tagged string. In step 340, the tagged strings of the source code can be automatically replaced with the generated placeholders. In step 345, target language strings can be linked to each applicable placeholder value. In one embodiment, the target language strings and associations can be specified in an association file, such as a JAVA .properties file in a JAVA based embodiment. In step 350, a report is generated showing results of the localization process, such as how many placeholders were generated and whether each placeholder was associated with a corresponding target language string.

In steps 355 and 360, the placeholder containing source code can be compiled or optimized to produce an executable customized for the target language. In step 365, the method can determine whether another build should occur for a different target language. If so, the method can proceed from step 365 to step 330, where each tagged string can be associated with a corresponding string of the target language. When no executable for an additional target language is to be generated, the method can progress to step 370, where a check can be performed to see if a change to the source code has occurred. When there is a change in the source code, however, the method can proceed from step 370 to step 310, where source code strings can be automatically detected. If no change has occurred, the method can end, as indicated by step 375.

The present invention may be realized in hardware, software or a combination of hardware and software. The present invention may be realized in a centralized fashion in one computer system or in a distributed fashion where different elements are spread across several interconnected computer systems. Any kind of computer system or other apparatus adapted for a carrying out methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following; a) conversion to another language, code or notation; b) reproduction in a different material form.

This invention may be embodied in other forms without departing from the spirit or essential attributes thereof. Accordingly, reference should be made to the following claims, rather than foregoing the specification, as indicating the scope of the invention.

What is claimed is:

1. A method for localizing source code strings comprising:
identifying software source code that includes a set of base language strings;
detecting the base language strings by an executing software routine;
visually presenting the source code within a graphical user interlace along with visual indicators to identity the software detected base language strings;
receiving user input to annotate details of the base language strings;
for each base language string, determining an equivalent string in a target language;
replacing each base language string with an automatically generated placeholder to construct language independent source code;
indexing each placeholder against the target language string associated with to the base language string that the placeholder replaced; and
generating an executable customized for the target language from the indexing results and the language independent source code.

2. The method of claim 1, where the steps of claim 1 are performed in a software development environment utilizing a set of software development tools specifically customized for purposes of completing the method steps.

3. The method of claim 1, wherein the identifying, detecting, presenting, receiving, and determining steps occur in a software development environment, and wherein the replacing, indexing, and generating steps occur in a runtime environment.

4. The method of claim 1, further comprising:
specifying a set of build parameters, which are combined with the indexing results and the language independent source code during the generating step to create the executable.

5. The method of claim 3, wherein the source code is JAVA code, wherein the language independent source code is defined in a .java file, wherein the build parameters are defined in a .localization file, and wherein the indexing results are defined in a .properties file.

6. The method of claim 1, wherein the replacing, indexing, and generating steps are performed by a build engine during a software build, and wherein the executable is a compiled version of the source code, which has been customized for the target language.

7. The method of claim 1, further comprising;
using a software tool to generate a build report that specifies execution details of the replacing and indexing steps.

8. The method of claim 1, further comprising:
presenting a language specifying interface for specifying target language equivalents for each of the detected base language strings; and
receiving user input via the language specifying interface that defines target language strings which correspond to detected base language strings, wherein the determining step utilizes the received user input.

9. The method of claim 1, wherein said steps of claim 1 are steps performed automatically by at least one machine in accordance with at least one computer program having a plurality of code sections that are executable by the at least one machine, said at least one computer program being stored in a machine readable medium.

10. Development software for localizing source code comprising:
a localizable string detection engine configured to automatically detect each base language string contained in source code;
a placeholder generation engine configured to create a placeholder for each detected base language string and to substitute each base language string of the source code with a created placeholder;
a target-language-to-placeholder indexing engine configured to index each placeholder of the source code against a target language item, wherein the target language item that is indexed is associated with a base language string that the indexed placeholder replaced; and
a build engine configured to automatically generate an executable customized for the target language based upon an index file generated by the target-language-to-placeholder indexing engine and a modified source code file generated by the placeholder generation engine.

11. The development software of claim 10, further comprising:
a source code viewer interface configured to visually distinguish automatically detected base language strings within source code from other source code text.

12. The development software of claim 11, further comprising at least one interface element of the source code viewer configured to permit a user to categorize options for an associated base language string, wherein the categorization options include a string indication option, an error indication option, an information item indication option, and a warning option.

13. The development software of claim 10, further comprising:
a language specification interface configured to present each of the detected base language strings and to permit a user to specify/edit a target language item that corresponds to each of the detected base language strings, wherein target language items used by the target-language-to-placeholder indexing engine include items modified via the language specification interface.

14. The development software of claim 12, further comprising:
a language specification interface configured to present each of the detected base language strings and to permit a user to specify/edit a target language item that corresponds to each of the detected base language strings, wherein target language items used by the target-language-to-placeholder indexing engine include items modified via the language specification interface, wherein the build engine is driven by a tagged source file that includes categorization information specified by a user via the interface element of claim 12 and a language file created using the language specification interface.

15. The development software of claim 10, further comprising:
a report generation interface configured to automatically generate reports that are scorecards including information about a number of tagged and untagged source code strings and a metrics expressing a success of matches between the generated placeholders and the target language items.

16. A software development interface comprising:
a source code viewer configured to visually distinguish automatically detected base language strings within source code from other source code text, wherein each of the automatically detected base language strings are strings that are to be localized through actions taken via the software development interface;
at least one interface element of the source code viewer configured to permit a user to categorize options for an associated base language string; and
a user selectable execution element for automatically generating a tagged version of software source code, which incorporates user specified categorization information entered via the at least one interface element, wherein a software routine uses the tagged version of the software source code to generate a language independent version of the source code within which each of the detected base language strings has been replaced by an automatically generated placeholder.

17. The software development interface of claim 16, wherein the categorization options include a string indication option, an error indication option, an information item indication option, and a warning option.

18. The software development interface of claim 16, further comprising:
a language specification interface configured to present each of the detected base language strings and to permit a user to specify/edit a target language string that corresponds to each of the detected base language strings, wherein target language strings that have been presented in the language specification interface are indexed against each of the automatically generated placeholders so that each target language string is associated with a placeholder that has replaced a base language string corresponding to the target language string.

19. The software development interface of claim 18, further comprising:
a build creation interface configured to permit a user to selectively create a software build based upon the source code, wherein at least one of the options of the build interface automatically creates an executable based upon a user specified file for a language independent version of the source code and based upon a user specified indexed file that indexes the automatically generated placeholders and the target language strings established through the language specification interface, wherein an execution initiated by the build interface option results in an executable customized for the target language.

20. The software development interlace of claim 19, further comprising:
a report generation interface element configured to automatically generate reports that are scorecards including information about a number of tagged and untagged source code strings and a metrics expressing a success of matches between the generated placeholders and the target language strings when generating the executable customized for the target language.
